(19) United States
(12) Patent Application Publication
(10) Pub. No.: US 2026/0268366 A1
(43) Pub. Date: Sep. 10, 2026

(54) IMAGE CLASSIFICATION FOR ECOMMERCE PLATFORM

(71) Applicant: Capital One Services, LLC, McLean, VA (US)

(72) Inventors: Deepak RAMAMOHAN, Bangalore (IN); Joydeep DASGUPTA, Bangalore (IN); Amrit Presanna KUMAR, Bangalore (IN); Kshitij MATHUR, Bangalore (IN); Debashish ROY, Bangalore (IN)

(73) Assignee: Capital One Services, LLC, McLean, VA (US)

(21) Appl. No.: 19/073,738

(22) Filed: Mar. 7, 2025

(51) Int. Cl. G06Q 30/0241; G06F 16/55

(52) U.S. Cl. CPC G06Q 30/0241; G06F 16/55

(57) ABSTRACT

A method for classifying an image includes generating a repository of sampled electronic images by grouping images received from an entity into categories based on product type and sampling a subset of the received images within a subset of the categories. The method further includes clustering vector embeddings of the sampled images to create a series of image clusters. Then, an image is selected from each cluster in the series of image clusters where a similarity measurement between images in the cluster is within a predefined range.

### BACKGROUND

Image classification systems are useful in various industries, such as healthcare, retail, and manufacturing, where they aid in quick and automatic decision making. Current image classification systems include machine learning classifier models, rule based detection, and template matching. Despite their capabilities, many conventional image classification systems face a variety of technical challenges that limit their practical deployment in real-world systems. These challenges are particularly apparent for applications where large amounts of labeled data are not available.

### BRIEF DESCRIPTION OF THE DRAWINGS/FIGURES

The accompanying drawings are incorporated herein and form a part of the specification.

FIG. 1 shows an example block diagram of an image classification system architecture, according to some aspects.

FIG. 2 shows an example block diagram of data structure for an ecommerce environment, according to some aspects.

FIG. 3 shows an example process for generating a repository of images, according to some aspects.

FIG. 4 shows an example block diagram of a database, according to some aspects.

FIG. 5 shows an example process for classifying an image, according to some aspects.

FIG. 6 shows an example computer system according to some aspects.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

The invention described herein relates to systems, methods, and computer program implementations for classifying electronic images.

An ecommerce platform, or online marketplace, may host product listings for multiple entities (e.g., sellers), such that the entities may post images of their products on the ecommerce platform. In some instances, the entities may post images that are not directly related to a product or post images that includes portions that are not directly related to the product. For example, if the entity is a car dealership, the entity may post images advertising sales and special offers in addition to images of a vehicle being sold. As a result, when a user of the ecommerce platform searches for a product, an irrelevant product image may be displayed, making the platform less user friendly and not optimally operating for its intended purpose. Accordingly, it is advantageous for a host of an ecommerce platform to classify images in a manner such that features and images irrelevant to a product can be identified and/or removed from the platform.

Several image classification systems exist in the art. For example, machine learning based classifiers may be trained to predict a label for a given input image. Similarly, rule based detection models may determine a set of rules that are used to detect anomalies (e.g., irrelevant images) in a system. These models rely on large amounts of labeled data. Labeled data is often unavailable for a specific use case, and must be created manually, which is costly and time consuming. Furthermore, the types of irrelevant images displayed on the ecommerce platform may change periodically, requiring updates to the image classification system, and in some cases, new labeled data.

The approaches disclosed herein overcome the technical deficiencies that exist in the art. In embodiments, an image classification system determines if an image is relevant by matching the image to images contained within a repository of irrelevant images. To create the repository of irrelevant images, the image classification system may first group images received from an entity into categories based on product type and sample a subset of the received images within a subset of the categories. The image classification system may then cluster vector embeddings of the sampled images to create a series of image clusters.

Thereafter, the image classification system selects an image from each cluster in the series of image clusters where a similarity measurement between images in the cluster is within a predefined range. The selected images form a repository of irrelevant images. New images are classified as relevant or irrelevant through similarity comparisons between the new image and its nearest neighbors in the repository of irrelevant images.

The approaches described herein provide direct technical improvements over other image classification methods. For example, the repository of irrelevant image is created and updated automatically, removing the need for manual image labeling. Furthermore, the sampling scheme used to generate the repository of irrelevant images increases computational efficiency. This technical advantage may be appreciated in resource-constrained environments and large-scale image classification systems.

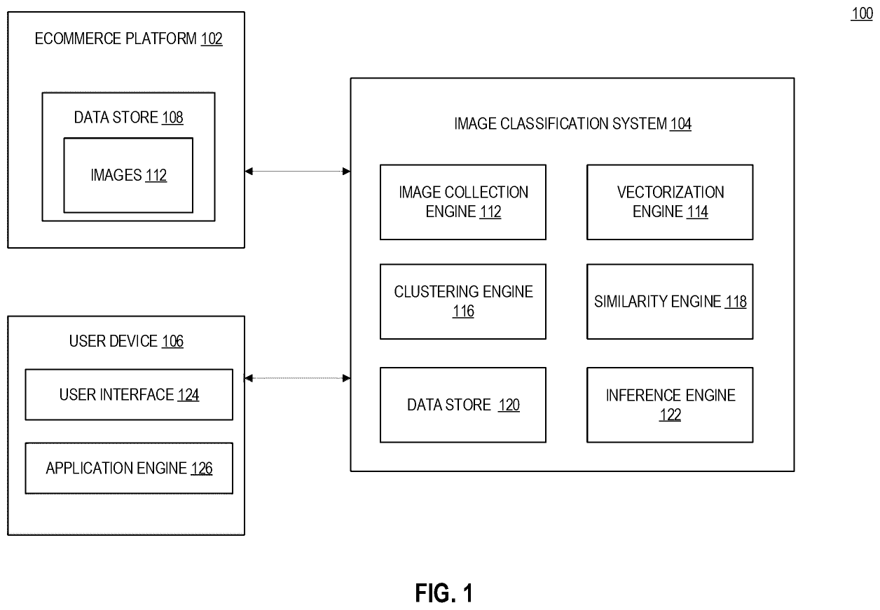

FIG. 1 shows an example block diagram of an image classification system architecture 100, according to some aspects. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Example image classification system architecture 100 may include an ecommerce platform 102, an image classification system 104, and a user device 106. In some aspects, example image classification system architecture 100 may be implemented partially or entirely at user device 106. Alternatively or additionally, in some aspects, example architecture 100 may be implemented partially or entirely at third party servers or within the cloud. In such aspects, user device 106, image classification system 104, and ecommerce platform 102 may be communicatively coupled with each other via one or more networks, such as one or more wired or wireless local area networks (“LANs,” including Wi-Fi, mesh networks, Bluetooth, near-field communication, etc.) or wide area networks (“WANs,” including the Internet, cellular networks, etc.).

In some aspects, ecommerce platform 102 may allow one or more entities to manage and sell products or services online. Ecommerce platform 102 may include a data store 108. Data store 108 may include a relational database that stores structured data related to entities, products, customers, orders, etc. For example, data store 108 may include images 110 of products sold on ecommerce platform 102. Images 110 may include both images of products and irrelevant images (e.g., advertisements, posters, etc.)

In some aspects, image classification system 104 may collect and classify images. For example, image classification system 104 may create a repository of irrelevant images contained within data store 108. Image classification system 104 may then compare new images to images in the repository of irrelevant images to determine if the new images are relevant to a product sold on ecommerce platform 102. Image classification system 104 may include an image sampling engine 112, a vectorization engine 114, a clustering engine 116, a similarity engine 118, a data store 120, and an inference engine 122.

Image collection engine 112 may be configured to sample images contained within a data store. For example, image collection engine 112 may use query based sampling to sample images 110 from data store 108. Image collection engine 112 may also utilize uniform sampling techniques.

Vectorization engine 114 may convert images, such as the images collected by image collection engine 112, into vector embeddings (e.g., condensed, numerical forms that help efficiently compare images). For example, vectorization engine 114 may leverage techniques including convolutional neural network based models, or transformer-based models to generate dense vector representations for images. This enables image classification system 102 to effectively compare new images to a database of irrelevant images.

Clustering engine 116 may perform clustering on data within image classification system 104. For example, clustering engine 116 may cluster images sampled by image collection engine 112 into groups based on similarity. Clustering engine 116 may employ various clustering strategies and techniques, such as, but not limited to, hierarchical clustering (e.g., agglomerative clustering, divisive clustering, etc.), density-based clustering (e.g., DBSCAN, OPTICS, etc.), partitioning clustering (e.g., k-means clustering, k-medoids clustering, etc.), or model-based clustering (e.g., Gaussian mixture models, Dirichlet process mixtures, etc.).

Similarity engine 118 may calculate a similarity between two or more images. For example, similarity engine 118 may calculate a similarity between an image and its nearest neighbors in a repository of irrelevant images. Similarity engine 118 may employ various strategies and techniques, such as, but not limited to, cosine similarity, Euclidean distance, Jaccard similarity, etc.

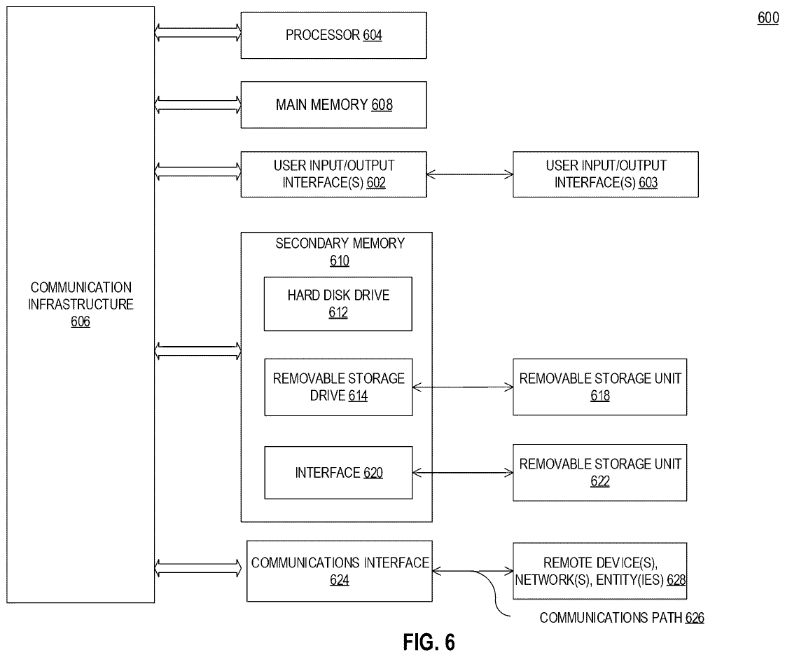

Data store 120 may store various data used by image classification system 104. For example, data store 120 may store a repository of irrelevant images. Data store 120 may be stored, for example, in a volatile memory (e.g., random access memory (RAM)), a non-volatile storage device (e.g., a disk), or in a distributed and/or redundant manner across multiple memories and/or storage devices. In some aspects, data store 120 is managed by and accessed via a corresponding database management system (DBMS), which is not shown in FIG. 1 for the sake of simplicity. Data store 120 and the corresponding DBMS may be implemented on one or more computer systems, such as computer system 600 as described below in reference to FIG. 6. Data store 120 and the corresponding DBMS may also be implemented on one or more servers of an enterprise network and/or a cloud computing network.

Inference engine 122 may classify an image as relevant or irrelevant. For example, inference engine 122 may receive a similarity score between an image and its nearest neighbors in a repository of images. Inference engine 122 may then compare the similarity score to a threshold range. If the similarity score falls within the threshold range, the image may be marked as irrelevant, otherwise the image may be marked as relevant.

User device 106 may be one or more of a desktop computer, a laptop computer, a tablet, a mobile phone, a smart appliance such as a smart television, and/or a wearable apparatus of the user that includes a computing device (e.g., a smartwatch, smart glasses, or a virtual or augmented reality computing device). Additional and/or alternative user devices are within the scope of this disclosure. User device 104 may include a corresponding user interface 124 and application engine 126.

User interface 124 may be configured to render content including unimodal responses, multimodal responses, or other content for audible or visual presentation to a user of user device 106 using one or more user interface output devices. For example, user device 106 may include a display or projector that enables content to be provided for visual presentation to a user via user device 106. Alternatively or additionally, user device 106 may include one or more speakers that enable content to be provided for audible presentation to a user via user device 106.

Application engine 126 may execute one or more software applications on user device 106. Application engine 126 may execute one or more software applications that are separate from an operating system of the user device 106 or may alternatively be implemented directly by the operating system of user device 106. For example, the application engine 126 may execute one or more software applications via a web browser or assistant.

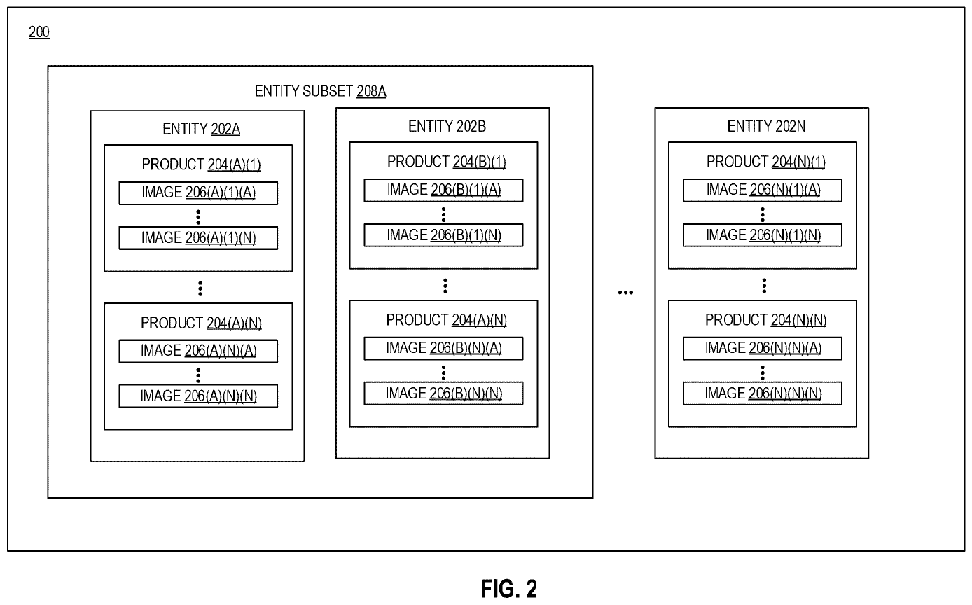

FIG. 2 shows a block diagram of an example data structure 200, according to some aspects. Data structure 200 may be an example of a data structure for an ecommerce platform, such as ecommerce platform 102 in FIG. 1. Data structure 200 may include entities 202 (i.e., entities 202A, 202B . . . 202N). Each entity 202 may include products 204 (e.g., products 204(A)(1)-204(A)(N), 204(B)(1)-204(B)(N), . . . 204(N)(1)-204(N)(N)). Products 204 may include images 206 (i.e., images 206(A)(1)(A)-206(A)(1)(N) . . . 206(A)(N)(A)-206(A)(N)(N), etc.). In some aspects, entities 202 are merchants that sell products 204 within environment 200. For example, entities 202 may include car dealerships, electronic stores, antique dealers, and the like. Products 204 may include vehicles, cell phones, laptops, furniture, and the like. Images 206 may include electronic images of products 204, and irrelevant images including advertisements, etc. Entities 202 may be grouped to form entity subsets 208. For example, in FIG. 2, entity 202A and entity 202B are grouped into entity subset 208A. Entities 202 may be grouped into entity subsets 208 based on commonalities including common ownership, common market segment, common region, and the like. In one non-limiting example, entities 202 are car dealerships and entity subsets 208 are car dealership franchises. Data structure 200 may be continuously updated as new entities, products, and images are added to an ecommerce platform.

The example data structure described above is not meant to be limiting nor meant to represent an exhaustive list of possible implementations. The scope of the technology disclosed herein is not limited to only these examples, and other implementations are contemplated as appreciated by one skilled in the art.

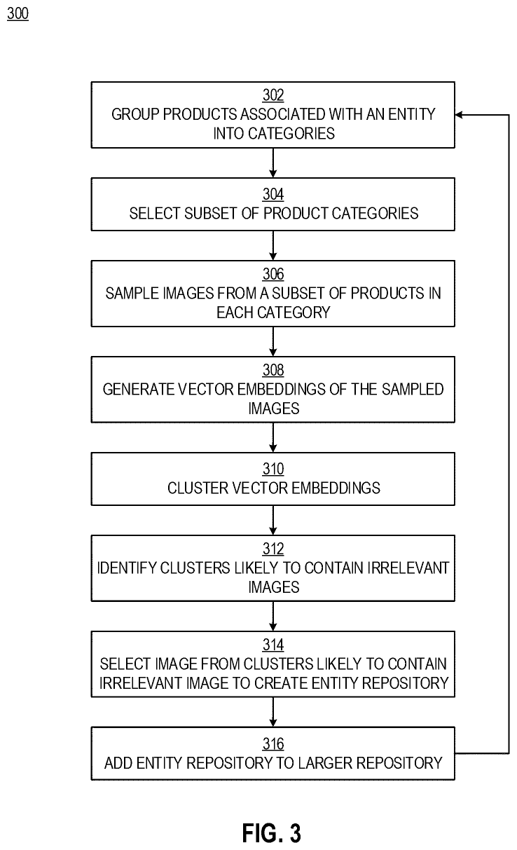

FIG. 3 shows a flowchart of an example process 300, according to some aspects.

Process 300 may describe a method for categorizing irrelevant images. The steps of process 300 described below may be implemented by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein.

Further, some of the steps may be performed simultaneously, or in a different order than described for FIG. 3, as will be understood by a person of ordinary skill in the art. Process 300 shall be described with reference to FIGS. 1-2. However, process 300 is not limited to those example aspects.

At step 302, an image classification system may group products (e.g., products 204(A)(1)-204(A)(N)) associated with an entity (e.g., entity 202A) into product categories. Product categories may include groupings of identical, or nearly identical products. In one non-limiting example, the product categories are year, make, and model groupings of vehicles (e.g., 2004 Toyota Camry, 2010 Honda Accord, etc.). In another example, the product categories are smartphone models or laptop models (e.g., IPhone SE, IPhone 18, AMD processors, Intel processors, etc.)

In some aspects, the product categories are pre-defined. For example, the product categories may be outlined in metadata (e.g., tags) of each product. The image classification system may group the products into categories based on the metadata.

Grouping the products into product categories enables the image classification system to account for products with identical, but still relevant images. For example, a black 2025 Honda Accord with a basic interior trim and a black 2025 Honda Accord with a premium interior trim may have identical exterior images, but distinct interior images. Grouping both Honda Accords into the same product category may prevent the identical exterior images from being marked as irrelevant in the classification scheme described below.

At step 304, the image classification system may select a subset of the project categories. For example, if the image classification system groups the products into n project categories, g categories may be selected. In some example implementations, g may be equal to n. In other implementations, g<n. For example, g may be greater than 20% of n, greater than 40% of n, greater than 60% of n, or greater than 80% of n. The value of g may be a set value that is determined based on the average number of product categories in an ecommerce system (e.g., g≈10-15).

At step 306, the image classification system may sample images from a subset of products in each product category. For example, if a product category contains m products, s products may be selected, where s≤m. In non-limiting examples, the subset of products, s, may be about 80% of m, 60% of m, 40% of m, or 20% of m. The value of s may range from around 5-10 to around 100 or more. When sampling is completed, images from s*g products are compiled into an image repository for the entity.

At step 308, the image classification system may generate vector embeddings for each of the images in the image repository created in step 306. The image classification system may leverage a vectorization engine (e.g., vectorization engine 114) to generate the vector embeddings. The vectorization engine may leverage techniques including convolutional neural network based models, or transformer-based models to generate condensed, numerical vector representations of the images. The resulting vector embeddings may capture features, patterns and semantics of the images. Vector embeddings make it easier to compare images in later steps of process 300. For example, generating vector embeddings allows the images to be compared based on their patterns and semantic meaning instead of comparing individual pixels.

At step 310, the image classification system may cluster the vector embeddings of the images. The image classification system may leverage a clustering engine (e.g., clustering engine 116) to cluster the vector embeddings into groups based on similarity. The clustering engine may utilize a density based clustering algorithm such as DBSCAN, or the like. For example, a density based clustering algorithm may cluster data by identifying neighboring data points (e.g., vector embeddings of images) within a defined radius. If the number of neighboring data points meets a threshold number, a cluster is formed. Data points that do not form a cluster are labeled as noise. Density based clustering algorithms are advantageous for applications, such as process 300, where many data points (e.g., image vector embeddings) are unique and may not form a cluster.

At step 312, the image classification system may identify clusters that are likely to include irrelevant images. To accomplish this, the image classification system may determine whether or not each cluster meets one or more criteria. One criteria may be the similarity between the vector embeddings of the images contained within each cluster. The image classification system may leverage a similarity engine (e.g., similarity engine 118) to calculate the similarity between images in a cluster and compare the similarity to a predefined threshold range. If the similarity engine calculates similarity using a distance based method, such as Euclidean distance, the similarity threshold may be between 0.01 and 0.1. Alternatively, if the similarity engine uses cosine similarity, the similarity threshold may be between 0.90-0.99.

Another criteria is the number of images in a cluster. The image classification system may identify clusters with a number of images greater than a threshold value, k. Clusters with larger numbers of images are more likely to contain irrelevant images. This is because irrelevant images, such as advertisements, are often repeated across several both several products and product categories. In some aspects, k may be chosen such that an image is only marked as irrelevant if it is repeated in over half of the products sampled (e.g., k≥2(s*g)+1).

At step 314, the image classification system may select an image from each of the clusters identified in step 312. Any image may be selected from the cluster and, in some aspects, the image selected is the image closest to the centroid (e.g., average of all data) of the cluster. The selected images represent the irrelevant advertisements identified across the product categories of the entity. The image classification system may compile the selected images into an entity repository.

At step 316, the entity repository is added to a larger data store. The entity repository may be added to a vector data store, such as data store 120. The data store may be partitioned such that each entity may be queried separately.

In some aspects, steps 302-316 of process 300 are repeated for other entities (e.g., entity 202B, . . . 202N). Steps 302-316 may be performed for multiple entities in parallel. This creates multiple repositories, where each repository is associated with an entity. Steps 302-316 may be repeated in batches. Process 300 may be repeated periodically (e.g., weekly, monthly) to update the entity repositories.

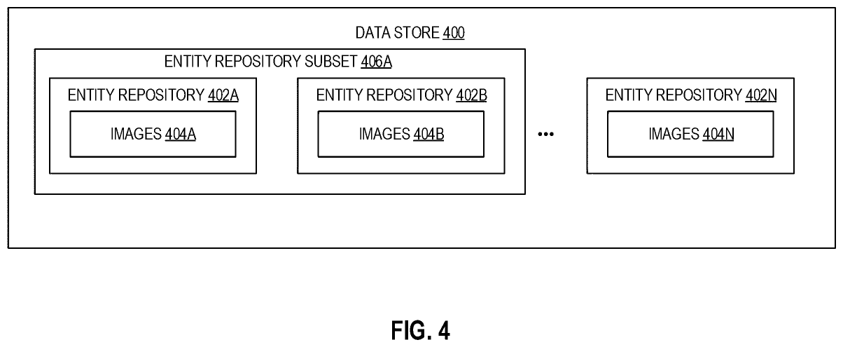

FIG. 4 shows an example data store 400, according to some aspects. Data store 400 may be an example of data store 120 in FIG. 1. Data store 400 may include a plurality of entity repositories 402. Each entity repository 402 may include irrelevant images 404 collected from each entity as described in reference to FIG. 3. For example, entity repository 402A may include images 404A collected from entity 202A (of FIG. 2), entity repository 402B may include images 404B collected from entity 202B, and entity repository 202N may include images 404N collected from entity 202N. Entity repositories 402 may be grouped into entity repository subsets 406. In the example shown in FIG. 4, entity repository 402A and entity repository 402B are grouped into entity repository subset 406A. Similar to entities 202, entity repositories 402 may be grouped based on commonalities including common ownership, common market segment, common region, and the like. Entity repository subsets 406 may map to the entity subsets 208 described in FIG. 2.

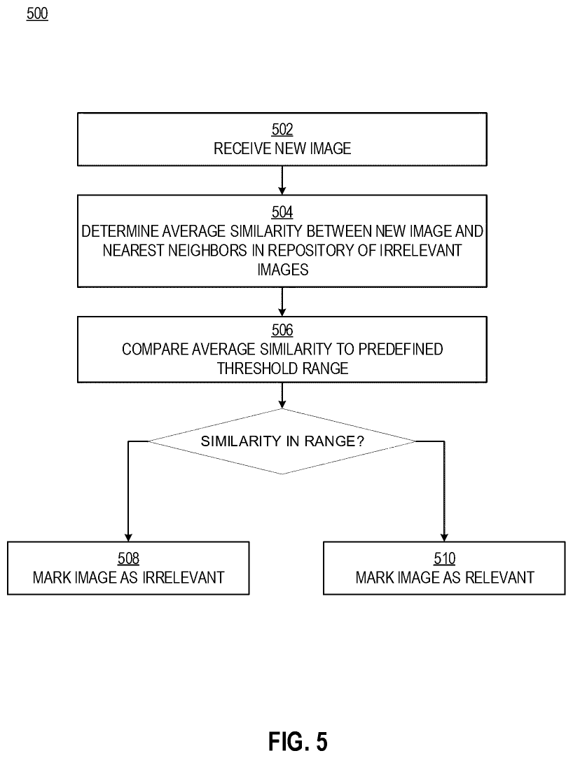

In some aspects, data store 400 is a vector database. A vector database may index, store, and manage data in the form of vector embeddings. A vector database also enables similarity based searches, such as those described below in FIG. 5. Data store 400 may have a flat index, which stores data directly without any modifications. Alternatively, data store 400 may have graph index that organizes data into a graph structure.

The example data store described above is not meant to be limiting nor meant to represent an exhaustive list of possible implementations. The scope of the technology disclosed herein is not limited to only these examples, and other implementations are contemplated as appreciated by one skilled in the art.

FIG. 5 shows a flowchart of a process 500, according to some aspects. Process 500 may describe a method for classifying an image. The steps of process 500 described below may be implemented by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than described for FIG. 5, as will be understood by a person of ordinary skill in the art. Process 500 shall be described with reference to FIGS. 1-4. However, process 500 is not limited to those example aspects.

At step 502, an image classification system may receive an image. The image may be a new image of a product sold on an ecommerce platform.

At step 504, the image classification system may determine an average similarity between an embedding of the new image and its nearest neighbors from a data store. In some aspects, the data store is a repository of irrelevant images, such as data store 400 in FIG. 4. The image classification system may leverage a vectorization engine (e.g., vectorization engine 114) to convert the image into a vector embedding. Then the image classification system may query the data store to determine the nearest neighbors of the new image.

Nearest neighbors may be found using techniques such as locally sensitive hatching and the like. In some aspects, dimension reduction methods are applied to the vector embeddings to speed up determination of the nearest neighbors. Examples of dimension reduction techniques may include principal component analysis, t-distributed stochastic neighbor embedding (t-SNE), and the like. Approximate nearest neighbor algorithms may also speed up determination of the nearest neighbors. Approximate nearest neighbor algorithms are particularly useful when the data store is large.

After the nearest neighbors are determined, the image classification system may leverage a similarity engine (e.g., similarity engine 118) to calculate the similarity between the image and its nearest neighbors.

In some aspects, the similarity engine may determine the average similarity between the vector embedding of the new image and its nearest neighbors using subsets of the database. For example, a vector embedding may only be compared with images in a repository for a single entity (e.g., entity repository 202A) or a repository for a subset of entities (e.g., entity repository subset 406A). In some embodiments, comparing a vector embedding to a smaller number of images may speed up computation time. In other embodiments, comparing a vector embedding to a larger group may provide better recall.

At step 506, the image classification system may compare the average similarity to a predefined threshold range. The values in the predefined threshold range may depend on the similarity calculation utilized by the similarity engine. For example, when using distance based similarity methods, such as Euclidean distance, small values of similarity indicate a close match and the predefined threshold, t may fall into the range: 0<t<0.05, with a preferred range of 0<t≤0.02. When using cosine similarity, high values of similarity indicate a close match and the predefined threshold, t may into the range, 0.9<t<1, with a preferred range of 0.98≤t<1. If the average similarity is within the similarity threshold range, the new image is marked as irrelevant at step 508. If the average similarity is outside of the similarity threshold range, the new image is marked as relevant at step 510.

In some aspects, irrelevant images are further categorized based on labels applied to the irrelevant images nearest neighbors within the database. For example, if an irrelevant images nearest neighbors are labeled “automobile dealer award poster”, the irrelevant image is also categorized as an automobile dealer award poster.

Images that are marked as irrelevant may be further processed by a host of an ecommerce platform, such as ecommerce platform 102. For example, an irrelevant image may be moved to the end of an image carousel so it does not appear in search results.

FIG. 6 depicts an example computer system 600, according to some aspects. Various aspects may be implemented, for example, using one or more well-known computer systems, such as computer system 600 shown in FIG. 6. One or more computer systems 600 may be used, for example, to implement any of the aspects discussed herein, as well as combinations and sub-combinations thereof. For example, the example computer system may be implemented as part of ecommerce platform 102, image classification system 104, user device 106, etc. Cloud implementations may include one or more of the example computer systems operating locally or distributed across one or more server sites.

Computer system 600 may include one or more processors (also called central processing units, or CPUs), such as a processor 604. Processor 604 may be connected to a communication infrastructure or bus 606.

Computer system 600 may also include customer input/output device(s) 602, such as monitors, keyboards, pointing devices, etc., which may communicate with communication infrastructure 606 through customer input/output interface(s) 602.

One or more of processors 604 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 616. Removable storage unit 616 may include a computer usable or readable storage device having stored thereon computer software (control logic) and/or data. Removable storage unit 616 may be a floppy disk, magnetic tape, compact disk, DVD, optical storage disk, and/any other computer data storage device. Removable storage drive 614 may read from and/or write to removable storage unit 616.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 616 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 6. In particular, aspects can operate with software, hardware, and/or operating system implementations other than those described herein It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A method for classifying images, comprising:
generating, by one or more computer systems, a repository comprising a plurality of sampled electronic images including products, the generating including grouping images received from an entity into categories based on the products and sampling a subset of the received images within a subset of the categories;
clustering, by the one or more computer systems, by implementing a density based clustering algorithm, vector embeddings of the plurality of sampled electronic images to create a series of image clusters;
for each individual cluster in the series of image clusters, calculating, by the one or more computer systems, a similarity score that describes the similarity between vector embeddings of images within the individual cluster;
determining, by the one or more computing systems, a subset of clusters within the series of clusters that contain advertisements by identifying which clusters in the series of clusters have both a similarity score greater than a threshold value and a number of images greater than an image threshold;
selecting, by the one or more computer systems, an image from each image cluster in the subset of clusters within the series of image clusters to create a database of advertisements associated with the entity;
computing, by the one or more computer systems, an average distance based similarity value between a vector embedding of a new received image and its nearest neighbors from the database of advertisements; and
classifying, by the one or more computer systems, the new received image as an advertisement when the average distance based similarity value is above an advertisement threshold range.

2. (canceled)

3. The method of claim 1, further comprising:
repeating, by the one or more computer systems, the generating, clustering, calculating, determining, and selecting for one or more additional entities in a subset of similar entities within an ecommerce system to create one or more additional databases of advertisements;
combining, by the one or more computer systems, the database of advertisements with the one or more additional databases of advertisements to create a combined database of advertisements for the subset of similar entities within the ecommerce system;
generating, by the one or more computer systems, an average distance based similarity value between an embedding of another new received image and its nearest neighbors from the combined database of advertisements; and
determining, by the one or more computer systems, if the another new received image is an advertisement by comparing the average distance based similarity value to the advertisement threshold range.

4. The method of claim 1, further comprising:
repeating, by the one or more computer systems, the generating, clustering, calculating, determining, and selecting for all additional entities in an ecommerce system to create additional databases of advertisements;
combining, by the one or more computer systems, the database of advertisements with the additional databases of advertisements to create a combined database of advertisements;
generating, by the one or more computer systems, an average distance based similarity value between an embedding of another new received image and its nearest neighbors from the combined database of advertisements; and
determining, by the one or more computer systems, if the another new received image is an advertisement by comparing the average distance based similarity value to the advertisement threshold range.

5. The method of claim 4, further comprising indexing, by the one or more computer systems, vector embeddings of images in the combined database of advertisements.

6. The method of claim 3, wherein the subset of entities comprises car dealerships within a franchise.

7. The method of claim 1, wherein the similarity threshold range is about 0.98-1 and the image threshold is a value greater than about 20% of the number of images in the plurality of sample images.

8. A system, comprising:
a memory; and
a processor coupled to the memory configured to:
generate a repository comprising a plurality of sample electronic images including products, by grouping images received from an entity into categories based on the products and sampling a subset of images within a subset of the categories;
cluster, by implementing a density based clustering algorithm, vector embeddings of the plurality of sample electronic images to create a series of image clusters;
calculate, for each individual cluster in the series of image clusters, a similarity score that describes the similarity between vector embeddings of images within the individual cluster;
determine a subset of clusters within the series of clusters that contain advertisements by identifying which clusters in the series of clusters have both a similarity score greater than a threshold value and a number of images greater than an image threshold;
select an image from each cluster in the subset of clusters within the series of image clusters to create a database of advertisements associated with the entity;
compute an average distance based similarity value between a vector embedding of a new received image and its nearest neighbors from the database of advertisements; and
classify the new received image as an advertisement when the average distance based similarity value is above an advertisement threshold range.

9. (canceled)

10. The system of claim 8, wherein the processor is further configured to:
repeat the generating, clustering, calculating, determining, and selecting for one or more additional entities in a subset of similar entities within the ecommerce system to create one or more additional databases of advertisements;
combine the database of advertisements with the one or more additional databases of advertisements to create a combined database of advertisements for the subset of similar entities within the ecommerce system;
generate an average distance based similarity value between an embedding of another new image and its nearest neighbors from the combined database of advertisements; and
determine if the another new image is an advertisement by comparing the average distance based similarity value to the advertisement threshold value.

11. The system of claim 8, wherein the processor is further configured to:
repeat the generating, clustering, calculating, determining, and selecting for all additional entities in the ecommerce system to create additional databases of advertisements;
combine the database of advertisements with the additional databases of advertisements to create a combined database of advertisements;
generate an average distance based similarity value between an embedding of another new image and its nearest neighbors from the database of advertisements; and
determine if the another new image is an advertisement by comparing the average distance based similarity value to the advertisement threshold range.

12. The system of claim 11, wherein the processor is further configured to index vector embeddings of images in the combined database of advertisements.

13. The system of claim 10, wherein the subset of entities comprises car dealerships in a franchise.

14. The system of claim 8, wherein the similarity threshold range is between about 0.98-1 and the image threshold is a value greater than about 20% of the number of images in the plurality of sample images.

15. A non-transitory machine readable storage medium having instructions stored thereon that, when executed by a set of one or more processors, cause said set of one or more processors to perform operations comprising:
generating a repository comprising a plurality of sampled electronic images including products, the generating including grouping images received from an entity into categories based on the products and sampling a subset of the received images within a subset of the categories;
clustering, by implementing a density based clustering algorithm, vector embeddings of the plurality of sample electronic images to create a series of image clusters;
for each individual cluster in the series of image clusters, calculating a similarity score that describes the similarity between vector embeddings of images within the individual cluster;
determining a subset of clusters within the series of clusters that contain advertisements by identifying which clusters in the series of clusters have both a similarity score greater than a threshold value and a number of images greater than an image threshold;
selecting an image from each cluster in the subset of clusters within the series of image clusters to create a database of advertisements associated with the entity;
computing an average distance based similarity value between a vector embedding of a new received image and its nearest neighbors from the database of advertisements; and
classifying the new received image as an advertisement when the average distance based similarity value is above an advertisement threshold range.

16. (canceled)

17. The non-transitory machine readable storage medium of claim 15, the operations further comprising:
repeating the generating, clustering, calculating, determining, and selecting for one or more additional entities in a subset of similar entities within the ecommerce system to create one or more additional databases of advertisements;
combining the database of advertisements with the one or more additional databases of advertisements to create a combined database of advertisements for the subset of similar entities within the ecommerce system;
generating an average distance based similarity value between an embedding of another new image and its nearest neighbors from the combined database of advertisements; and
determining if the another new image is an advertisement by comparing the average distance based similarity value to the advertisement threshold range.

18. The non-transitory machine readable storage medium of claim 15, the operations further comprising:
repeating the generating, clustering, calculating, determining, and selecting for all additional entities in the ecommerce system to create additional databases of advertisements;
combining the database of advertisements with the additional databases of advertisements to create a combined database of advertisements;
generating an average distance based similarity value between an embedding of another new image and its nearest neighbors from the combined database of advertisements; and
determining if the another new image is an advertisement by comparing the average distance based similarity value to the advertisement threshold range.

19. The non-transitory machine readable storage medium of claim 18, the operations further comprising indexing vector embeddings of images in the combined database of advertisements.

20. The non-transitory machine readable storage medium of claim 15, wherein the similarity threshold range is between about 0.98-1 and the image threshold is a value greater than about 20% of the number of images in the plurality of sample electronic images.
